(19) United States
(12) Patent Application Publication
(10) Pub. No.: US 2013/0345046 A1
(43) Pub. Date: Dec. 26, 2013

(54) Bifunctional Catalyst for Decomposition and Oxidation of Nitrogen Monoxide, Composite Catalyst Including the Same for Apparatus to Decrease Exhaust Gas, and Method for Preparation Thereof

(71) Applicant: Korea Institute of Engergy Research, Daejeon (KR)

(72) Inventors: Jong-Soo Park, Daejeon (KR); Kyung-Ran Hwang, Daejeon (KR); Young-Jae Lee, Daejeon (KR); Soon-Kwan Jeong, Daejeon (KR); Dong-Kook Kim, Daejeon (KR); Sung-Ho Cho, Daejeon (KR); Chun-Boo Lee, Daejeon (KR)

(73) Assignee: Korea Institute of Engergy Research, Daejeon (KR)

(21) Appl. No.: 14/012,037

(22) Filed: Aug. 28, 2013

Related U.S. Application Data
(62) Division of application No. 13/139,500, filed on Jun. 13, 2011.

(30) Foreign Application Priority Data
Dec. 12, 2008 (KR) 10-2008-0126650
Apr. 30, 2009 (KR) 10-2009-0038462

(51) Int. Cl. B01J 29/78; B01J 23/652

(52) U.S. Cl. CPC B01J 29/7815; B01J 23/6527
USPC 502/66; 502/309; 502/308; 502/314

(57) ABSTRACT

Disclosed are a bifunctional catalyst for simultaneously removing nitrogen oxide and particulate matters, capable of decomposing nitrogen monoxide and generating nitrogen dioxide through oxidation of nitrogen monoxide, a composite catalyst including the catalyst for simultaneously removing nitrogen oxide and particulate matters used for an apparatus to decrease exhaust gas of diesel vehicles, and a method for preparation thereof. The catalyst and the composite catalyst can be used in a device for reducing exhaust gas contaminants mounted on a diesel vehicle and an exhaust gas purification system comprising the device.

### RELATED APPLICATIONS

This application is a Divisional of application Ser. No. 13/139,500, filed Jun. 13, 2011, which claims priority to National Stage Application of International Application No. PCT/KR2009/007422, filed Dec. 11, 2009, entitled “Dual Functional Catalysts for Decomposition and Oxidation of Nitrogen Monoxide, Mixed Catalysts for Exhaust-Gas Reducing Device Including the Same, and Preparation Method Thereof, which claims priority to Korean Patent Application No. 10-2008-0126650, filed on Dec. 12, 2008, entitled, “Bi-functional catalyst for decomposing and oxidizing nitric oxide simultaneously and its preparation method therein”, which is incorporated herein by reference in its entirety; and also claims priority to Korean Patent Application No. 10-2009-0038462, filed on Apr. 30, 2009, entitled, “Mixtured catalyst for emission reduction device of diesel vehicles and preparing method for the same”, which is incorporated herein by reference in its entirety.

### TECHNICAL FIELD

The present invention relates to a bifunctional catalyst for simultaneously removing nitrogen oxide and particulate matters, capable of decomposing nitrogen monoxide and generating nitrogen dioxide through oxidation of nitrogen monoxide, a composite catalyst including the catalyst for simultaneously removing nitrogen oxide and particulate matters used for an apparatus to decrease exhaust gas of diesel vehicles, and a method for preparation thereof.

More particularly, the present invention relates to a bifunctional catalyst for simultaneously removing nitrogen oxide and particulate matters, which may enable generation of nitrogen dioxide and, at the same time, decomposition of nitrogen monoxide and include a support containing metal oxide as well as a composite active metal, that has a co-catalyst of metal or metal oxide loaded on top of the support and an active metal of metal or metal oxide loaded on top of the co-catalyst; a composite catalyst for an apparatus to decrease exhaust gas of diesel vehicles, which includes the bifunctional catalyst, beta-zeolite, an inorganic binder and a dispersant; and a method for preparation thereof.

### BACKGROUND ART

In recent years, due to strict regulation for carbon dioxide (CO₂) exhaust emission in overall industries, a demand for fuel-efficient (that is, high fuel economy) vehicles has shown a tendency to increase. For this reason, compared to diesel engines or conventional gasoline engines, a demand for a vehicle equipped with a gas direct injection (GDI) type engine having excellent energy efficiency has tended to increase. Comparing the diesel engine and GDI engine, when fuel combustion occurs in an engine chamber, the combustion of the fuel is carried out using more oxygen than is required in a theoretical air fuel ratio, in turn increasing efficiency of combustion and improving fuel economy. However, the foregoing entails disadvantages of high concentration of nitrogen oxides which refer to both of nitrogen monoxide (NO) and nitrogen dioxide (NO₂) (hereinafter, referred to as ‘NOₓ’). Since contaminants such as nitrogen oxide, particulate matters, etc., seriously affect human health, emission regulations of nitrogen oxides and particulate matters have been strengthened throughout the world.

Specifically, a great effort has been made to remove NOₓ as a primary cause of an increase in ozone concentration, destruction of the ozone layer and acid rain in the lower atmosphere, and systems for treatment of vehicle exhaust gas such as Lean NOₓ Trap (LNT), a selective catalytic reduction (SCR), etc., are known to exhibit high NO decomposition efficiency. Among those, SCR includes a reductive reaction using a reducing agent such as hydrogen carbide (HC), ammonia (NH₃), urea, etc., to reduce NO into nitrogen in a presence of a catalyst (see Equation 1). A flow charge of a system for post-treatment of exhaust gas through the foregoing is shown in FIG. 1.

NOₓ+HC (or urea)→N₂+CO₂+H₂O Equation 1

As shown in FIG. 1, an un-combusted hydrogen carbide and carbon monoxide contained in the exhaust gas emitted from an engine 100 are oxidized on a diesel oxidation catalyst 600, in turn being harmless. Particulate matters (PMs) are trapped by a diesel particulate filter 300 while nitrogen oxide contained in the exhaust gas is subjected to reductive reaction on a selective reduction catalyst 500 as well as a reducing agent provided from a rear end of the filter, in turn being reduced into N₂.

Here, an SCR catalyst using urea may be prepared and used by loading or ion-exchanging an active metal, which consists of a noble metal and/or a transition metal, on a zeolite support (see JP 2008-212799, and WO 2004/045766). Use of a composite oxide of titanium and tungsten as a catalyst support and use of an active metal selected from cerium, lanthanum, praseodymium, niobium, nickel and tin have been disclosed in U.S. Pat. No. 5,658,546. Regarding NOₓ reduction of using hydrogen carbide (HC-SCR), it was reported that excellent performance can be attained by loading tungsten on Zr—Ti composite oxide and loading Pt on an outer surface thereof (see Japanese Patent laid-open No. 2004-105964).

However, as shown in FIG. 1, a NOₓ removing system using a reducing agent needs a device for supplying the reducing agent and alternative reduction catalyst (SCR) 500 for removing NOₓ, thus incurring increased cost of maintenance due to supply of the reducing agent as well as initial investment costs.

On the other hand, if a catalyst for directly decomposing NOₓ is used, problems encountered in the foregoing SCR system using the reducing agent, that is, installation of an additional system for storage/provision of a reducing agent, control logic for driving system, increase in initial investment costs and wheeled transport costs, or the like, may be overcome.

NOₓ direct decomposition catalyst is used to decompose NOₓ into nitrogen and oxygen without using alternative reducing agents and extensive studies into industrial applications thereof have currently been conducted. According to such studies, it has been reported that transition metal loaded zeolite or perovskite catalysts may exhibit activity on NOₓ direct decomposition.

However, since the foregoing catalyst is activated at a high temperature of 500° C. or more, activity of the catalyst is too low to be employed in a catalyst system for removing exhaust gas having a distribution of considerably low temperatures and the catalyst has insufficient durability. In addition, due to a great amount of oxygen, moisture, sulfur, etc., contained in vehicle exhaust gas, the activity of the catalyst is considerably decreased, in turn requiring some reinforcement.

A bifunctional catalyst according to the present invention has excellent efficiency of decomposing nitrogen oxides (NOₓ) at 250 to 500° C. which is a distribution of temperatures for vehicle exhaust gas, no decrease in activity depending upon reaction time, and superior durability with regard to oxygen, moisture and sulfur. Furthermore, the bifunctional catalyst of the present invention may decompose nitrogen oxide, in particular, nitrogen monoxide (NO) and, at the same time, partially oxidize NO into NO₂ as a side product. When such NO₂ is fed into a diesel filter at a rear end thereof, this gas may have an important role in oxidation of PMs trapped in the filter.

In order to remove such PMs contained in the vehicle exhaust gas, most related industries have currently adopted a process that passes exhaust gas through a filter system including at least one selected from a group consisting of silicon carbide (SiC), cordierite and metal to trap PMs in the filter, in turn removing the same. In this case, as an amount of PMs accumulated in the filter is increased, problems such as engine overload may be caused. Such accumulated PMs are oxidized/removed using an oxidizing agent and thermal energy. Here, a process for removing PMs trapped in the filter is generally referred to as ‘regeneration’.

In general, when oxygen is used as an oxidizing agent to oxidize PMs trapped in a filter, filter regeneration may be executed at a temperature of 500° C. or more. Since a probability for formation a high temperature exhaust gas is extremely low under actual driving conditions of vehicles, there is a need to employ a natural generation system using an oxidizing agent having higher oxidation capability than oxygen in order to oxidize PMs at a relatively low temperature, and a forced regeneration system using a thermal energy supply device mounted on an outer side of the system to forcedly increase a temperature of the exhaust gas, thereby oxidizing PMs.

The latter, that is, the forced regeneration system requires a great amount of energy to elevate a temperature of exhaust gas to a regeneration temperature of 500° C. or more, in other words, involves excessive consumption of fuel, and entails a problem of deterioration in fuel economy due to repeated regeneration or increased pressure caused by PMs. Therefore, a systemic configuration using a better oxidizing agent than O₂ to oxidize PMs at a lower temperature is most suitable in view of operational costs.

As described above, when PMs trapped in the filter are oxidized by O₂, an oxidation initiating temperature is about 300° C., however, oxidation is not actively progressed until about 400° C. or more due to influence of contents of O₂, moisture, sulfur and HC contained in exhaust gas. On the other hand, if NO₂ is used as an oxidizing agent, an oxidation initiating temperature is about 100° C. and, since NO₂ is used to oxidize PMs, a filter regeneration temperature may be considerably decreased. FIG. 2 schematically illustrates a flow chart of a filter regeneration system to oxidize and remove PMs using NO₂ as an oxidizing agent.

The process described above includes converting NO, which accounts for more than 90% of NOₓ components in exhaust gas generated from the engine 100, into NO₂ on a noble metal catalyst 600 (see the following Equation 2) and inducing oxidation of PMs in a filter 300 by the generated NO₂ (see the following Equation 3).

As described above, a continuous regeneration type exhaust gas treatment system shown in FIG. 2 adopts a simple structure, does not need an additional energy source and shows excellent thermal efficiency. However, for vehicles having the foregoing system, a coefficient of NO utilization in a conventional catalyst system is relatively low. Accordingly, the foregoing system should be applied to only vehicles that have NO_{X}/PM concentration ratio of at least 20 in the exhaust gas and at least 50% of a total driving area in which a temperature of exhaust gas is 250° C. or more.

NO+1/2O₂→NO₂ Equation 2

NO₂+C (particulate matter)→N₂+NO+CO (or CO₂) Equation 3

Meanwhile, vehicles having difficulty in applying the continuous regeneration type exhaust gas treatment system, e.g., a vehicle driven at a low speed in urban areas must have a forced regeneration type device for post-treatment of exhaust gas shown in FIG. 3.

A significant feature of such a forced regeneration type exhaust gas post-treatment system is to heat the exhaust gas generated in the engine 100 to at least a regeneration temperature of 500° C. or more by a heater 400 for supplying thermal energy, in turn oxidizing PMs. Compared to the continuous regeneration type system for treatment of exhaust gas shown in FIG. 2, the foregoing system encounters a problem of increasing maintenance costs due to operation of the heater 400 to supply thermal energy. In particular, if a regeneration cycle is short, maintenance costs for heating the exhaust gas are considerably increased. Accordingly, there is a need to extend the regeneration cycle by applying a continuous regeneration type catalyst system to shorten the regeneration cycle to an existing forced regeneration exhaust gas system, in turn decreasing fuel consumption.

Extensive research and investigation into diesel particulate filters associated with post-treatment techniques, in order to comply with reinforced regulations for exhaust gas emission standards of diesel vehicles, has recently been conducted. In addition, studies into composite catalysts used in an apparatus for decreasing exhaust gas emission of diesel vehicles equipped with the foregoing diesel particulate filter having improved efficiency of removing particulate matters, have actively been conducted.

### DISCLOSURE

### Technical Problem

Therefore, the present invention is directed to solving problems described above and an object of the present invention is to provide a catalyst for simultaneously removing nitrogen oxide and particulate matters, based on bifunctional catalytic performance including nitrogen monoxide (NO) decomposition and nitrogen dioxide (NO₂) generation through NO oxidation under exhaust gas conditions with high oxygen concentration (>4% O₂), without using a reducing agent, while compensating defects of conventional exhaust gas post-treatment catalysts.

Another object of the present invention is to provide a method for manufacturing a catalyst capable of simultaneously removing nitrogen oxide and particulate matters, based on bifunctional catalytic performance including NO decomposition and NO₂ generation through NO oxidation under exhaust gas conditions with high oxygen concentration (>4% O₂), without using a reducing agent, while compensating for defects of conventional exhaust gas post-treatment catalysts.

Another object of the present invention is to provide a composite catalyst for an exhaust gas reducing device mounted on a diesel vehicle, which is applied to the device to improve efficiency of oxidizing un-combustible hydrogen carbide, carbon monoxide, nitrogen oxide, PM (particulate matter in exhaust gas), which are harmful to the human body, as well as the collection efficiency of carbon nanoparticles having a size of 30 nm or less.

Another object of the present invention is to provide a method for manufacturing a composite catalyst for an exhaust gas reducing device mounted on a diesel vehicle.

A still further object of the present invention is to provide an exhaust gas reducing device with improved capability of reducing nitrogen oxide, which contains a bifunctional catalyst for simultaneously removing nitrogen oxide and PM to enable NO decomposition and NO₂ generation through NO oxidation, or a composite catalyst for an exhaust gas reducing device mounted on a diesel vehicle, as well as an exhaust gas purification system having the same.

### Technical Solution

In order to accomplish the foregoing objects, according to an embodiment of the present invention, there is provided a bifunctional catalyst for simultaneously removing nitrogen oxide and particulate matters (PMs) to enable nitrogen monoxide (NO) decomposition and nitrogen dioxide (NO₂) generation through NO oxidation, the bifunctional catalyst comprising: a support containing oxides of at least one element selected from a group consisting of titanium (Ti), zirconium (Zr), silicon (Si), aluminum (Al) and cerium (Ce); and a composite active metal formed by loading a co-catalyst based on at least one metal selected from a group consisting of tungsten (W), molybdenum (Mo), cobalt (Co), manganese (Mn), copper (Cu) and iron (Fe) or metal oxides thereof on top of the support, and loading an active metal based on at least one metal selected from a group consisting of platinum (Pt), palladium (Pd), rhodium (Rh), ruthenium (Ru) and silver (Ag) on top of the co-catalyst.

According to the present invention, the co-catalyst may be loaded in an amount of 0.1 to 30 wt. % relative to a total weight of the support, while the active metal may be loaded in an amount of 0.1 to 10 wt. % relative to a total weight of the support.

According to the present invention, the co-catalyst may be loaded on an outer surface of the active metal and, preferably, an amount of the catalyst loaded on the support may range from 0.1 to 10 wt. % relative to a total weight of the support.

According to the present invention, an average particle diameter of the support may be larger than that of the composite active metal. Since average particle diameters are different therebetween, if a composite catalyst of the present invention is applied to an exhaust gas reducing device mounted on a diesel vehicle, a contact area between the composite catalyst and exhaust gas may be increased.

As a result, the exhaust gas reducing device coated with the composite catalyst mounted on the diesel vehicle may improve oxidation efficiency of harmful materials such as PM (particulate matter in exhaust gas) and collection efficiency of carbon nanoparticles having a size of 30 nm or less.

An average particle diameter of the support according to the present invention may range from 0.01 to 20 μm, preferably, 0.03 to 10 μm.

An average particle diameter of the composite active metal may range from 1 to 100 nm, preferably, 3 to 20 nm.

In addition, the present invention provides a method for preparation of a bifunctional catalyst for simultaneously removing nitrogen oxide and particulate matters (PMs) to enable nitrogen monoxide (NO) decomposition and nitrogen dioxide (NO₂) generation through NO oxidation, the method comprising: (a) loading a co-catalyst based on at least one metal selected from a group consisting of tungsten (W), molybdenum (Mo), cobalt (Co), manganese (Mn), copper (Cu) and iron (Fe) or metal oxides thereof on top of a support containing oxides of at least one element selected from a group consisting of titanium (Ti), zirconium (Zr), aluminum (Al) and cerium (Ce); (b) loading an active metal based on at least one metal selected from a group consisting of platinum (Pt), palladium (Pd), rhodium (Rh), ruthenium (Ru) and silver (Ag) or metal oxides thereof on top of the co-catalyst; and (c) drying, calcining and conducting reduction of the loaded materials after loading the co-catalyst and the active metal.

According to the present invention, the co-catalyst in step (a) may be loaded in an amount of 0.1 to 30 wt. % relative to a total weight of the support, and the active metal in step (b) may be loaded in an amount of 0.1 to 10 wt. % relative to a total weight of the support.

In addition, the co-catalyst and the active metal may be simultaneously or sequentially loaded in step (c).

According to the present invention, step (c) may further comprise: after simultaneously or sequentially loading the co-catalyst and the active metal and calcining the loaded materials to form a particulate catalyst, loading the co-catalyst on an outer surface of the active metal in the presence of the particulate catalyst; and, after loading the co-catalyst on the outer surface of the active metal, sequentially drying, calcining and conducting reduction of the loaded active metal. An amount of the co-catalyst loaded on the outer surface of the active metal may range from 0.1 to 10 wt. % relative to a total weight of the support.

The drying may be conducted at 100 to 110° C. for 10 to 15 hours, preferably, at 105° C. for 12 hours.

The calcination may be conducted at 500 to 600° C. for 3 to 7 hours in an air atmosphere, preferably, at 550° C. for 5 hours in an air atmosphere.

The reduction may be conducted at 200 to 400° C. for 0.5 to 5 hours in a hydrogen atmosphere, preferably, at 300° C. for 1 hour in a hydrogen atmosphere.

According to the present invention, a bifunctional catalyst for simultaneously removing nitrogen oxide and particulate matters, to enable decomposition of nitrogen monoxide (NO) and nitrogen dioxide (NO₂) generation through NO oxidation, may be prepared by the above method.

A bifunctional catalyst for simultaneously removing nitrogen oxide and particulate matters, which enables decomposition of NO and NO₂ generation through NO oxidation, may be applied to a structural body to attain a decrease in an amount of catalyst to be used, ensuring mechanical stability and improvement of durability, etc. The structural body referred to herein is a monolith or foam type structural material comprising metal and inorganic materials. Any structural material to which the inventive catalyst is applied to ensure favorable performance of the catalyst may be used during applying the catalyst and features or constructions of the structural body are not particularly limited.

A variety of methods for applying a catalyst to a structural body may be used.

For instance, the bifunctional catalyst prepared by the foregoing method is treated by wet milling to prepare a catalyst slurry and, after applying the prepared slurry to a monolith, honeycomb or diesel particulate filter (DPF) trap, the coated material is subjected to drying, calcining and reduction under the same conditions as those used in preparation of powdery catalyst, as described above, to thereby obtain a coating catalyst formed on the monolith, honeycomb or DPF trap. When the formed catalyst is canned and provided to a vehicle, nitrogen oxide and particulate matters generated from the vehicle may be simultaneously removed (see FIG. 5). The foregoing coating method is an illustrative example of a method for coating a structural body with the bifunctional catalyst of the present invention, however, coating procedures or processes are not particularly limited in the present invention.

The present invention also provides a composite catalyst for an exhaust gas reducing device mounted on a diesel vehicle, which includes the catalyst for simultaneously removing nitrogen oxide and particulate matters described above.

The composite catalyst for an exhaust gas reducing device according to the present invention may include beta-zeolite, an inorganic binder and a dispersant.

The catalyst for simultaneously removing nitrogen oxide and particulate matters of the present invention may be contained in an amount of 5 to 95 wt. % relative to a total weight of the composite catalyst. Preferably, the amount ranges from 30 to 60 wt. % and, more preferably, the amount ranges from 40 to 50 wt. %.

The inorganic binder used in the present invention may be any one selected from a group consisting of alumina, titania and silicone. An amount of the inorganic binder may range from 0.5 to 5 wt. % relative to a total weight of the composite catalyst.

The dispersant may be water or alcohol, without being particularly limited thereto.

In addition, the present invention provides a method for preparation of a composite catalyst for an exhaust gas reducing device mounted on a diesel vehicle, the method comprising: (a) loading a co-catalyst based on at least one metal selected from a group consisting of tungsten (W), molybdenum (Mo), cobalt (Co), manganese (Mn), copper (Cu) and iron (Fe) or metal oxides thereof on top of a support containing oxides of at least one element selected from a group consisting of titanium (Ti), zirconium (Zr), aluminum (Al) and cerium (Ce); (b) loading an active metal based on at least one metal selected from a group consisting of platinum (Pt), palladium (Pd), rhodium (Rh), ruthenium (Ru) and silver (Ag) or metal oxides thereof on top of the co-catalyst; (c) drying, calcining and conducting reduction after loading the co-catalyst and the active metal, to thereby obtain a catalyst powder; and (d) mixing the catalyst powder with beta-zeolite, an inorganic binder and a dispersant to produce a composite catalyst.

According to the present invention, steps (a) to (c) of the foregoing method are substantially the same as described above.

In step (d), the catalyst powder may be added in an amount of 40 to 60 wt. % relative to a total weight of the composite catalyst. The inorganic binder may be any one selected from a group consisting of alumina, titania and silicon, while the dispersant may be water or alcohol, without being particularly limited thereto.

The present invention also provides a device for reducing exhaust gas contaminants, comprising: the catalyst for simultaneously removing nitrogen oxide and particulate matters described above or the composite catalyst for an exhaust gas reducing device described above.

According to the present invention, the device for reducing exhaust gas contaminants, may include: a catalyst coated honeycomb fabricated by coating a honeycomb with the catalyst for simultaneously removing nitrogen oxide and particulate matters or the composite catalyst for an exhaust gas reducing device; and a filter, wherein the filter is connected to the catalyst coated honeycomb.

According to the present invention, the device for reducing exhaust gas contaminants, may include: a catalyst coated honeycomb fabricated by coating a honeycomb with the catalyst for simultaneously removing nitrogen oxide and particulate matters or the composite catalyst for an exhaust gas reducing device; and a filter for trapping particulate matters, wherein the filter is connected to the catalyst coated honeycomb.

According to the present invention, the device for reducing exhaust gas contaminants may include: a catalyst coated honeycomb fabricated by coating a honeycomb with the catalyst for simultaneously removing nitrogen oxide and particulate matters or the composite catalyst for an exhaust gas reducing device; and a catalyst coated diesel particulate filter (DPF) trap formed by coating an inner side of the DPF with the catalyst for simultaneously removing nitrogen oxide and particulate matters or the composite catalyst for an exhaust gas reducing device, wherein the catalyst coated DPF trap is connected to the catalyst coated honeycomb.

Further, the present invention also provides an exhaust gas purification system comprising the device for reducing exhaust gas contaminants described above.

According to the present invention, the exhaust gas purification system may further include a reducing agent supplying device.

An illustrative example of the exhaust gas purification system is schematically shown in FIG. 6. A catalyst enabling massive generation of NO₂ as well as reduction of nitrogen oxide may be applied to a honeycomb or monolith type support fabricated according to sequential order illustrated in FIG. 5. Here, the honeycomb or monolith may consist of ceramic or metal.

With regard to construction of the system, exhaust gas emitted from an engine 100 is subjected to NO decomposition and, at the same time, NO₂ generation on a surface of catalysts of a catalyst coated honeycomb 200, according to Equation 4. The generated NO₂ is reduced into N₂ or NO while oxidizing PMs trapped in a filter 300. According to this process, nitrogen oxide contained in the exhaust gas undergoes NO decomposition by the catalyst and generates NO₂ while decreasing an amount of the nitrogen oxide. The generated NO may be used as an oxidant for removing PMs, thereby continuously removing PMs trapped in the filter. In this case, the filter 300 may be any one consisting of ceramic or metal.

The exhaust gas purification system according to the present invention may also have an alternative construction as shown in FIG. 7.

The construction shown in FIG. 5 is applicable to an engine which emits exhaust gases having a very high NOₓ/PM ratio of 20 or more. However, if the NOₓ/PM ratio is low, nitrogen oxide may be decomposed by the catalysts of the catalyst coated honeycomb 200. Further, NO₂ selectivity is commonly 40% or less, thereby the above construction cannot provide a sufficient amount of oxidant (NO₂) required for PM oxidation. Accordingly, a catalyst coated honeycomb may be fabricated by applying the inventive catalyst to an inner side of DPF 310, in particular, to a surface of honeycomb and used to improve utilization of NO (see Equations 1 and 2 above). According to the fabricated honeycomb, when the DPF is exposed to a high temperature, PM contacting with the catalyst may be directly oxidized (see Equation 4) and, at the same time, NO reduced into an original condition by Equation 3 is again subjected to reaction according to Equation 2, thus generating NO₂. Therefore, the catalyst coated honeycomb according to the present invention may enhance NO use efficiency, in turn increasing an amount of PM to be removed.

C(PM)+O₂→CO₂(or CO) Equation 4

The exhaust gas purification system according to the present invention may have an alternative construction shown in FIG. 8. According to the construction shown in FIG. 8, decomposition rate of nitrogen oxide may be improved, compared to the construction shown in FIG. 7. About 10 to 30% of NO among a total volume of NOₓ contained in exhaust gas emitted from the engine 100 may be decomposed by the catalyst of the catalyst coated honeycomb 200 to generate N₂. On the other hand, about 10 to 40% of NO may be oxidized into NO₂. Since NO₂ is reduced into NO while oxidizing PM in the DPF 310, an amount of NO₂ remaining in the exhaust gas emitted from the DPF ranges from 65 to 85% relative to an initial concentration of NOₓ.

The foregoing passes through a rear catalyst coated honeycomb 210, thus further decreasing nitrogen oxide by 10 to 30%. Consequently, a total NOₓ decomposition efficiency may become 20 to 50%, therefore, the above construction may be effective when it is applied to vehicles having high NOₓ/PM ratio.

### DESCRIPTION OF DRAWINGS

The above and other objects, features and other advantages of the present invention will be more clearly understood from the following detailed description taken in conjunction with the accompanying drawings, in which:

FIG. 1 is a view schematically illustrating a purification system for PM and nitrogen oxide;

FIG. 2 is a view schematically illustrating a continuous regeneration type (CRT) exhaust gas purification system;

FIG. 3 is a view schematically illustrating a forced regeneration type exhaust gas purification system;

FIG. 4 is a flow chart illustrating a process for preparation of a powder catalyst according to the present invention;

FIG. 5 is a flow chart illustrating a process for manufacturing a device for reducing exhaust gas and contaminants, used for vehicle test;

FIG. 6 is a view illustrating a configuration example 1 of an exhaust gas purification system according to the present invention;

FIG. 7 is a view illustrating a configuration example 2 of an exhaust gas purification system according to the present invention;

FIG. 8 is a view illustrating a configuration example 3 of an exhaust gas purification system according to the present invention;

FIGS. 9 and 10 shows test results of Examples 1 to 3 and Comparative Example 1, especially, FIG. 9 shows NOₓ decomposition efficiencies and FIG. 10 shows NO₂ generation efficiencies;

FIG. 11 is a photograph showing mounting of a catalyst/filter according to Example 4;

FIG. 12 shows vehicle driving data (vehicle speed, temperature of exhaust gas, DOC+DPF differential pressure) of vehicle having the catalyst of Example 1 coated therewith;

FIG. 13 illustrates a variation of PM accumulation depending upon vehicle driving;

FIG. 14 is a schematic view illustrating a DOC support/ceramic filter coated with a composite catalyst for an exhaust gas reducing device for a diesel vehicle according to the present invention;

FIG. 15 is an SEM image showing a surface of the DOC support/ceramic filter coated with a composite catalyst prepared in Example 5 of the present invention;

FIG. 16 is an SEM image showing a cross-section of the DOC support/ceramic filter coated with a composite catalyst prepared in Example 5 of the present invention;

FIG. 17 is a schematic view showing a DOC support/ceramic filter coated with Pt—W/TiO2 prepared in Example 6 of the present invention;

FIG. 18 is an SEM image showing a surface of a DOC support/ceramic filter coated with Pt—W/TiO2 prepared in Example 6 of the present invention; and

FIG. 19 is an SEM image showing a cross-section of a DOC support/ceramic filter coated with Pt—W/TiO2 prepared in Example 6 of the present invention.

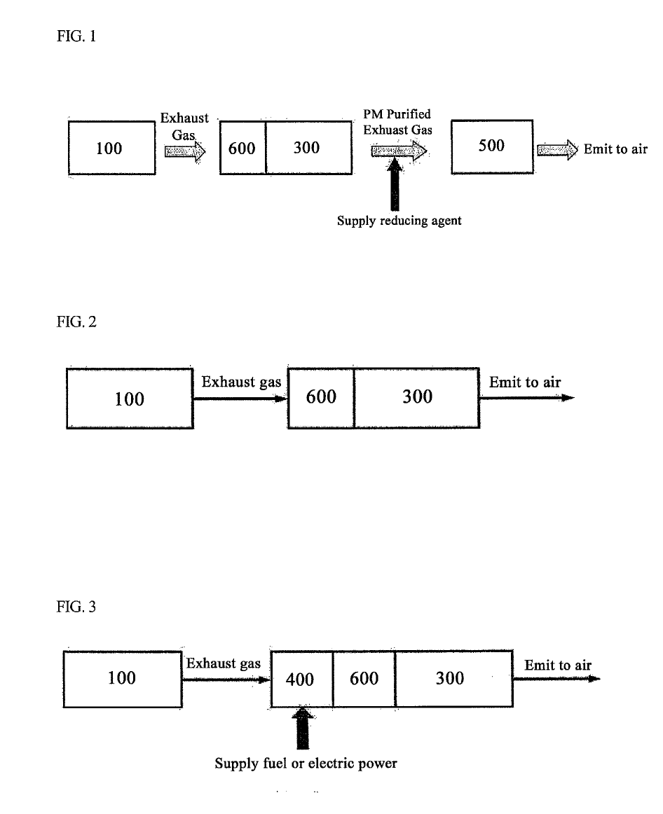

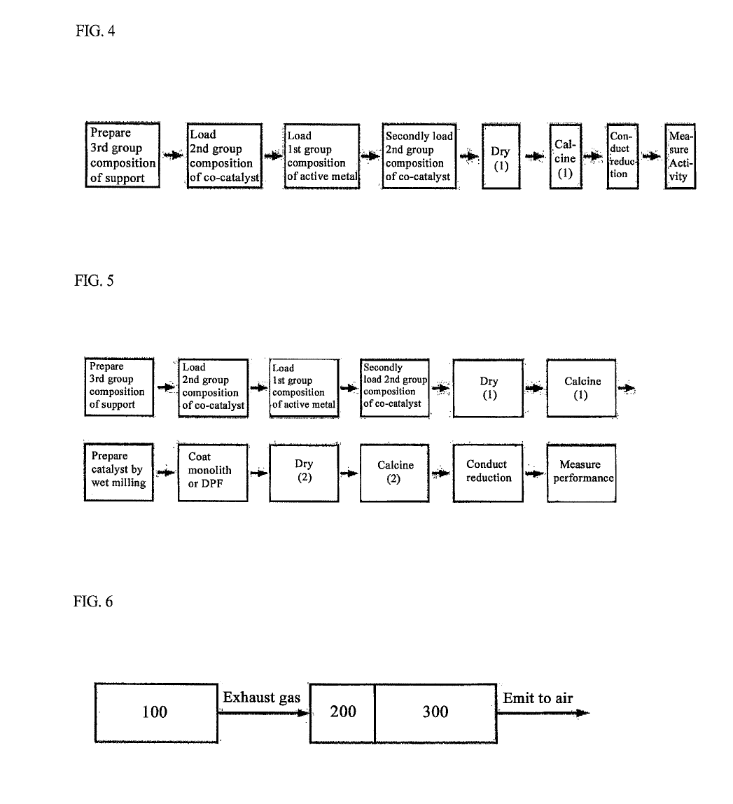

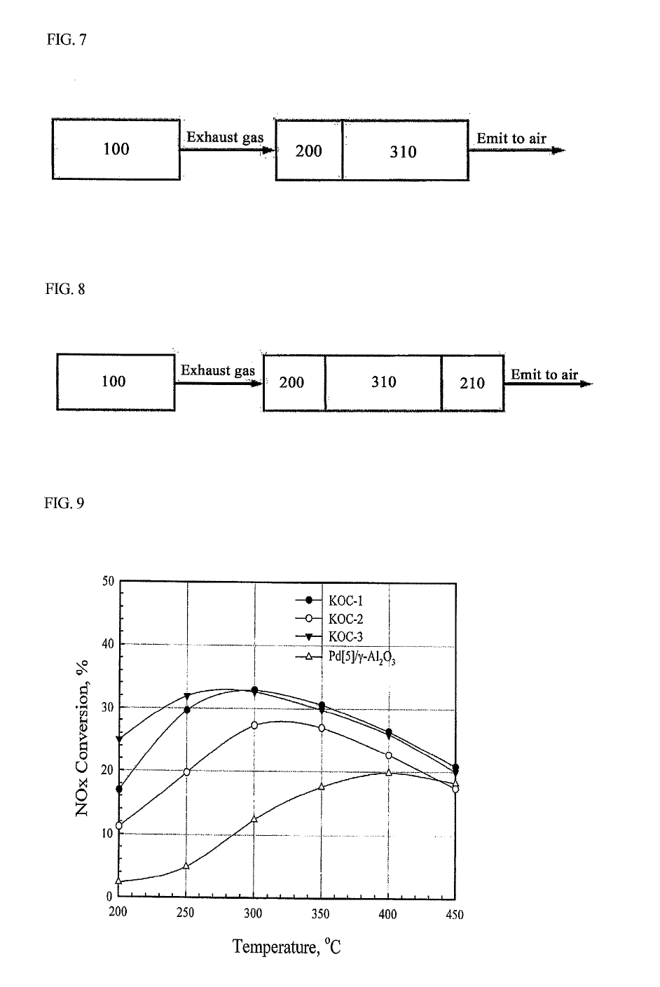

### DESCRIPTION OF SYMBOLS FOR MAJOR PARTS IN DRAWINGS

100: Engine, 200: Catalyst coated honeycomb
210: Rear catalyst coated honeycomb, 300: Filter
310: DPF, 400: Heater
500: SCR catalyst, 600: Diesel oxidation catalyst coated monolith

### BEST MODE

Exemplary embodiments of the present invention will be described in detail according to the following examples. However, the scope and spirit of the present invention disclosed in the appended claims are not restricted to the foregoing exemplary embodiments but include variations and/or equivalents of technical configurations of the invention.

### Example 1

A powder catalyst according to the present invention was prepared by the following procedures.

Titanium dioxide (TiO₂) powder was loaded in a water soluble solution containing an active metal and a co-catalyst component dissolved therein by an incipient-wetness method. Here, the used active metal and co-catalyst component were platinum (H₂PtCl₆.xH₂O, Aldrich Co.) and tungsten, respectively, individual precursors of these components were dissolved in distilled water such that contents of the loaded platinum and tungsten (Ammonium Tungstate, Aldrich Co.) became 2.0 wt. % and 5.0 wt. %, respectively, relative to a total weight of a support.

Thereafter, a catalyst component containing platinum and tungsten loaded therein was dried at 105° C. for 12 hours in an air atmosphere and calcined at 550° C. in an air atmosphere. The calcined product was milled and subjected to measurement of NOₓ decomposition performance. The catalyst was indicated as KOC-1.

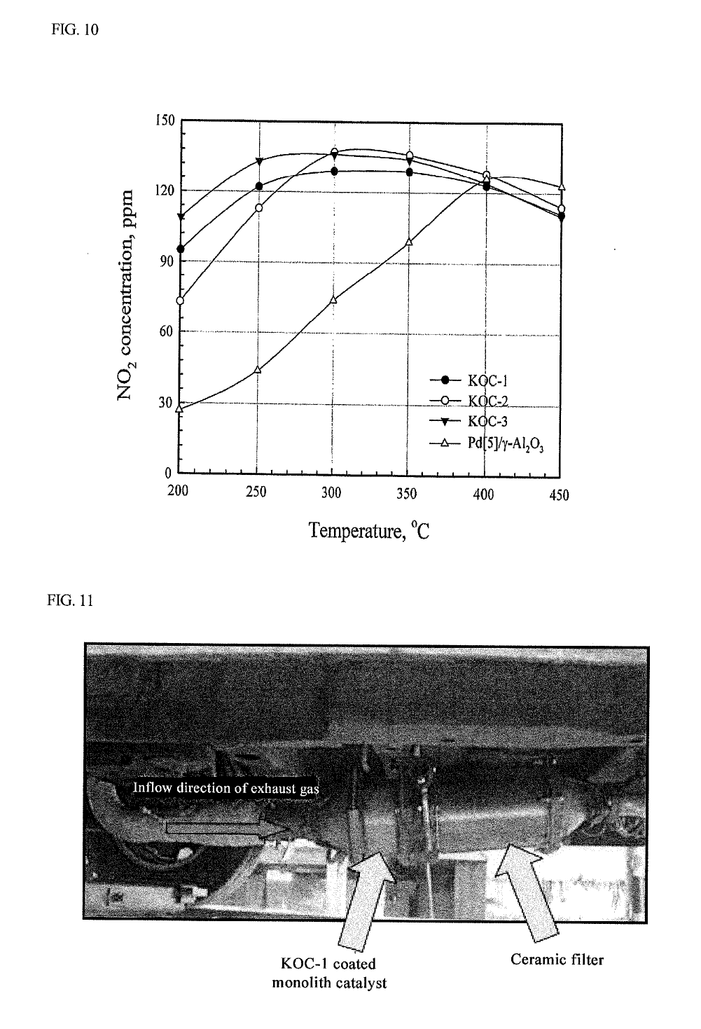

For KOC-1 catalyst prepared as described above, after conducting reduction at 300° C. for 30 minutes using a reductant gas (10 vol % H₂/N₂), NOₓ decomposition experiments were progressed. For NOₓ decomposition efficiency and NO₂ generation efficiency were examined under conditions of 12.5% oxygen, 300 ppm NOx, 5% moisture and GHSV=50,000/hr, which are similar to exhaust gas conditions of lean burn vehicles. Such examination results are shown in FIGS. 9 and 10. FIG. 9 shows NOₓ decomposition efficiency and FIG. 10 shows NO₂ generation efficiency.

As a result of experiments, it was found that NO_{X} decomposition capability and selectivity to NO₂ generation were considerably improved (in a range of 200 to 450° C.), compared to test results of Pt[5]/γ-Al2O3 (Comparative Example 1) generally used as an diesel oxidation catalyst (DOC) for exhaust gas purification of existing diesel engine automobiles.

In this regard, NOₓ removal rate may be calculated by the following mathematical equation 1 while NO₂ selectivity may be estimated by the following mathematical equation 2.

NOₓ removal rate=[concentration of NOₓ emitted from catalyst layer/concentration of NOₓ introduced into catalyst layer]×100 Math Equation 1

NO₂ selectivity=[concentration of NO₂ generated in catalyst layer/concentration of NO introduced into catalyst layer]×100 Math Equation 2

### Example 2

A catalyst was prepared by the same procedure described in Example 1, except that ZrO₂ was used as a support of the catalyst (referred to as KOC-2).

For KOC-2 catalyst prepared as described above, after conducting reduction at 300° C. for 30 minutes using a reductant gas (10 vol %, H₂/N₂) and before conducting NOₓ decomposition experiments, performance of the catalyst was evaluated. FIG. 9 illustrates NOₓ decomposition efficiency while FIG. 10 shows NO₂ generation efficiency.

As a result of determining catalyst activity, it can be seen that NO decomposition capability was greatly improved as compared to Pt[5]/Δ-Al2O3, and NOₓ decomposition capability and NO₂ generation selectivity were greatly improved as compared to commercially available catalysts.

### Example 3

Pt[2]-W[5]/TiO₂ was prepared by loading, drying and calcining active metal and co-catalyst according to the same procedures described in Example 1. In order to improve NOₓ decomposition capability and durability, tungsten (W) among a second group of co-catalysts was additionally loaded in an amount of 1.0 wt. % relative to a total weight of the support. Then, drying, calcining and reduction were conducted to prepare a catalyst. Such prepared catalyst was indicated to as KOC-3.

For KOC-3 catalyst prepared as described above, after conducting reduction at 300° C. for 30 minutes using a reductant gas (10 vol %, H₂/N₂) and before conducting NOₓ decomposition experiments, activity of the catalyst was evaluated. FIG. 9 illustrates NOₓ decomposition efficiency while FIG. 10 shows NO₂ generation efficiency.

As a result of determining catalyst activity, it can be seen that NOₓ decomposition capability and NO₂ generation selectivity were greatly improved as compared to Pt[5]/γ-Al2O3 and KOC-1.

### Example 4

A slurry solution was prepared by wet milling the catalyst KOC-1 powder according to Example 1. Ceramic monolith (400 cpi) was immersed into the slurry solution to coat a surface of the monolith with catalyst component. Immersion and drying were repeated until an amount of the catalyst coating reached 60 g/L. After drying, the coated monolith was subjected to calcination at 550° C. for 4 hours in an air atmosphere, then, reduction at 300° C. for 1 hour in a 10 vol % hydrogen/nitrogen atmosphere, thereby forming a DOC.

By combining the completed DOC (diameter of 14 cm, length of 7.3 cm, 400 cpi) with ceramic DPF (diameter of 14 cm, length of 23 cm, 200 cpi), an integrated can was fabricated and used to manufacture a contaminant reducing device.

The exhaust gas reducing device was mounted on an automobile, for example, commercially available under the trade mane CARNIVAL (with TCI engine, KIA Motors, Korea) (see FIG. 11) and PM trapping amount depending upon time was measured.

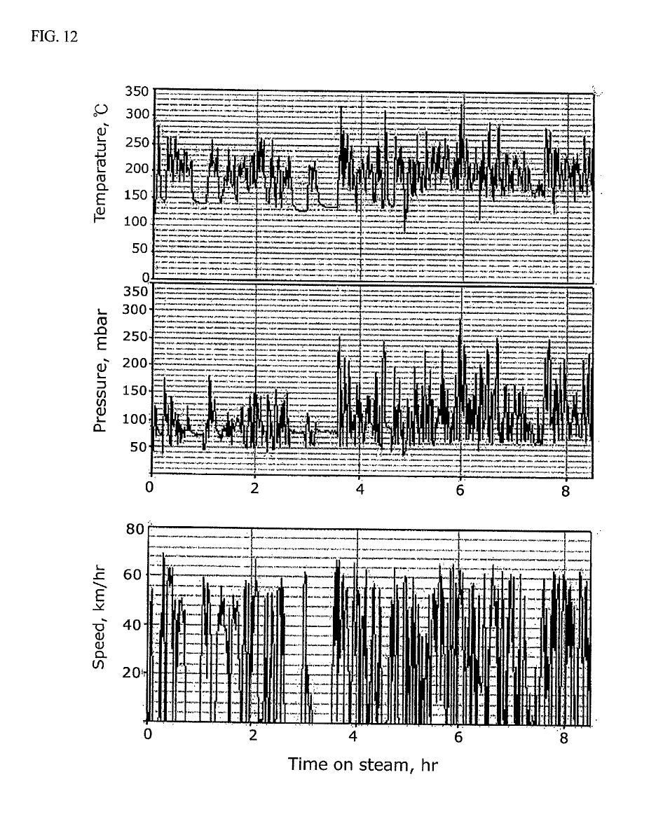

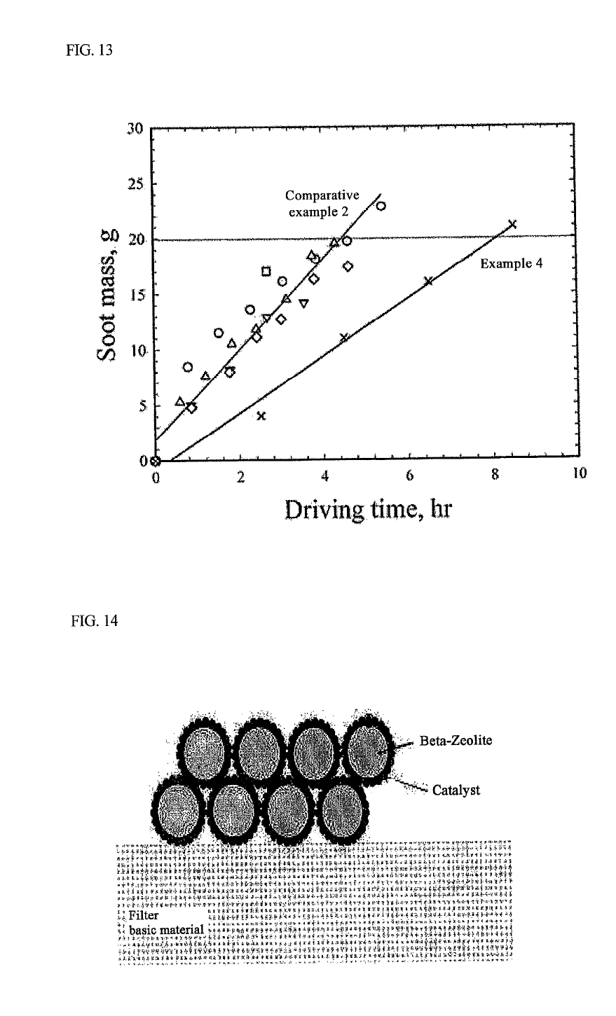

When the above automobile was driven with an average driving speed of 60 km/hr or less (see FIG. 12), weight of a filter was measured at a constant interval to estimate the PM trapping amount. Measured results are shown in FIG. 13.

In general, for a diesel vehicle equipped with a forced regeneration system, PM accumulation in DPF is proposed to be 5 g/L (20 g/4 L DPF). The reason for this is that DPF may be damaged by thermal energy given from the forced regeneration system as well as thermal energy generated by PM oxidation, if an amount of PM accumulation exceeds the above level.

With regard to the diesel vehicle having with the inventive catalyst, PM accumulation was measured. As a result, it was found that PM accumulation per hour was decreased to 50%, as compared to a control part having DOC/cDPF (a catalyst in Comparative Example 1 below). This means that, when 20 g of PM was accumulated in DPF and the forced regeneration system was operated, a system having commercially available DOC/cDPF (Pt[5]/γ-Al2O3) had to be periodically regenerated every 4 hours while a system using KOC-1 catalyst of the present invention enabled a regeneration period to be extended to 8 hours.

Accordingly, as shown in FIG. 2, if an exhaust gas purification apparatus having a forced regeneration device is used, fuel consumption may be decreased to 50% or less. Specifically, as the regeneration period is extended as described above, lifespan of an air compressor, a fuel pump, a battery, a fuel feeding valve, etc. may also be extended.

### Comparative Example 1

An oxidation catalyst Pt[5]/γ-Al2O3, commercially available in the art was prepared by the same procedures described in Example 1. Then, under the same conditions as described in Example 1, catalyst activity was measured.

Here, a support of the catalyst was γ-Al2O3 and, as an active ingredient of the catalyst, Pt was used in an amount of 5 wt. % relative to a total weight of the support.

### Comparative Example 2

The catalyst prepared in Comparative Example 1 was applied to a ceramic honeycomb and a filter (DPF; diameter of 14 cm, length of 23 cm, 200 cpi) by the same procedures described in Example 4, to thereby complete DOC/cDPF. Performance of the completed DOC/cDPF was determined. In this case, a catalyst coating amount on the filter was 20 g/L and drying, calcining and reduction were conducted by the same process as that used for preparation of DOC.

A result of the determination is shown in FIG. 13. PM trapping amount of DOC/cDPF was calculated by measuring difference in weights at a predetermined time interval during urban driving at 40 km/hr (◯), urban driving at 60 km/hr (Δ), country road driving at 80 km/hr (∇) and highway driving at 100 km/hr (□), respectively.

As a result, it was found that a time required to reach 20 g of PM accumulation is 4 hours regardless of driving patterns. Although when DPF was coated with the catalyst, PM accumulation was about 2 times as that in Example 4.

From the above description, it can be understood that ‘DOC/cDPF’ coated with an existing oxidation catalyst commercially available in the market cannot be employed in vehicles having relatively low exhaust gas temperature. Moreover, when the foregoing catalyst is applied to a forced regeneration system, a problem of increasing fuel consumption may be expected.

### Example 5

The powder catalyst prepared in Example 1, beta-zeolite (45 wt. %) having an average particle diameter of 400 nm and alumina sol (5 wt. %) as a binder were mixed together, followed by wet milling, in turn preparing a composite catalyst for an exhaust gas reducing device for a diesel vehicle.

### Example 6

In this example, the composite catalyst for an exhaust gas reducing device for a diesel vehicle prepared in Example 5 according to the present invention was coated with DOC/cDPF, and subjected to drying, calcining and reduction by the same procedures described in Example 4. The composite catalyst was applied in amounts of 60 g/L and 20 g/L to DOC and DPF, respectively.

As a result, DOC/cDPF coated with the composite catalyst of the present invention was obtained. FIG. 14 is a schematic view showing the coated DOC/cDPF. As shown in FIG. 14, it can be seen that the DOC/cDPF coated with the inventive composite catalyst has the composite catalyst with a small particle diameter uniformly distributed throughout an outer surface of beta-zeolite having a relatively large particle diameter.

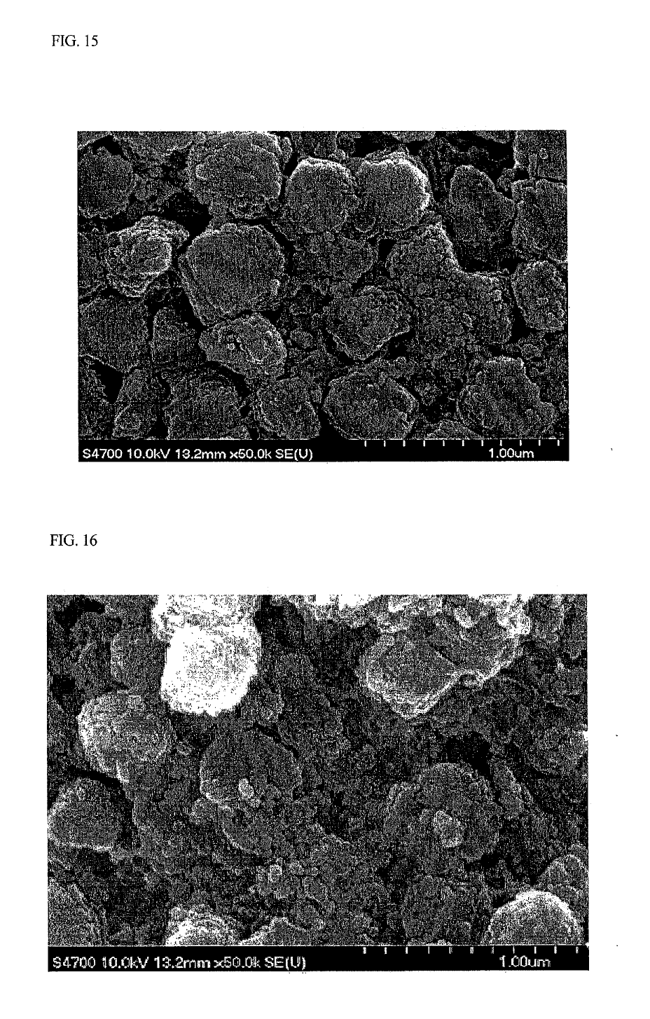

FIG. 15 is an SEM image showing a surface of DOC coated with the composite catalyst of the present invention, while FIG. 16 is an SEM image showing a cross-section of DOC coated with the composite catalyst of the present invention.

As shown in FIGS. 15 and 16, beta-zeolite having a large particle diameter comprises a porous structure and the composite catalyst of the present invention is uniformly distributed throughout an outer surface of the beta-zeolite, thereby confirming that a catalyst area capable of reacting with exhaust gas of the diesel vehicle is relatively large.

PM removal efficiency of DOC/cDPF was determined by the same procedures described in Example 4. However, experimental conditions were two different modes of 60 km/hr and 100 km/hr, respectively.
Results of the experiments are shown in TABLE 1.

As shown in TABLE 1, a PM accumulation rate where DOC/cDPF coated with the composite catalyst of the present invention is used, was 1.0 g/hr at a low speed mode of 60 km/hr while being −6.0 g/hr at a high speed mode of 100 km/hr. On the other hand, if DOC/cDPF in Comparative Example, that is, a control is used, it can be seen that PM accumulation rate demonstrates excellent driving efficiency.

TABLE 1
Comparison of catalyst performance

| | | PM accumulation | PM removal |
|---|---|---|---|
| Section | Driving mode | rate (g/hr) | efficiency (%) |
| DOC/cDPF in | 60 km/hr | 1.0 | 77.8 |
| Example 6 | 100 km/hr | −6.0 | 230.0 |
| DOC/cDPF in | 60 km/hr | 2.0 | 55.5 |
| Example 7 | 100 km/hr | −2.0 | 144.0 |
| Control | 60 km/hr | 4.5 | — |
| (Comparative | 100 km/hr | 4.5 | — |
| Example 2) | | | |

### Example 7

In this example, DOC/cDPF was coated using Pt—W/TiO2 proposed in Example 4 and according to the same procedure described in Example 6. However, a binder was added to Pt—W/TiO2 component without using beta-zeolite.

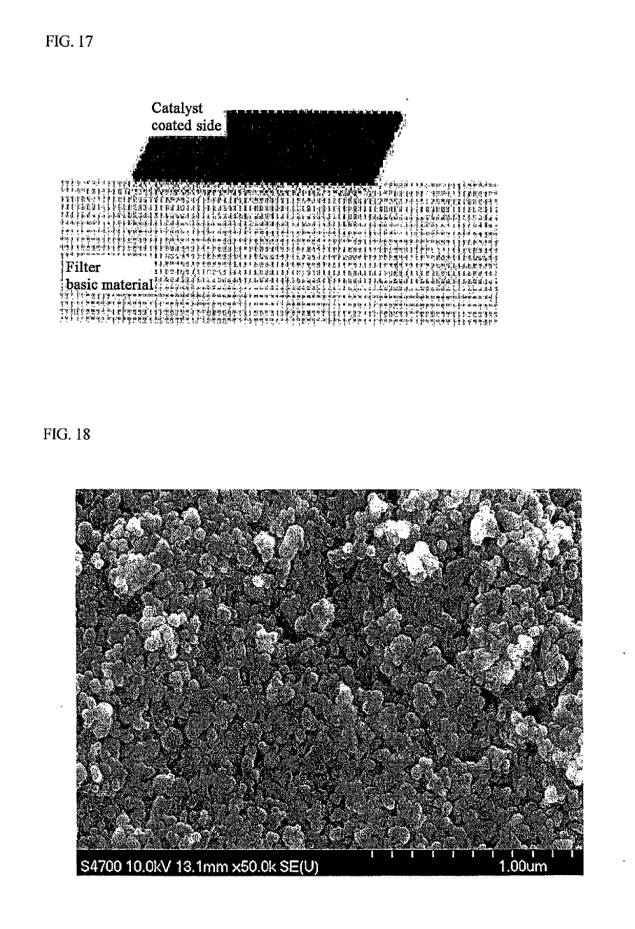

FIG. 17 is a schematic view illustrating the foregoing DOC/cDPF.

As shown in this schematic view, DOC/cDPF was coated with Pt—W/TiO2 as a fine catalyst having a uniform particle diameter, thereby confirming that a surface area of the catalyst capable of reacting with exhaust gas of a diesel vehicle is relatively small.

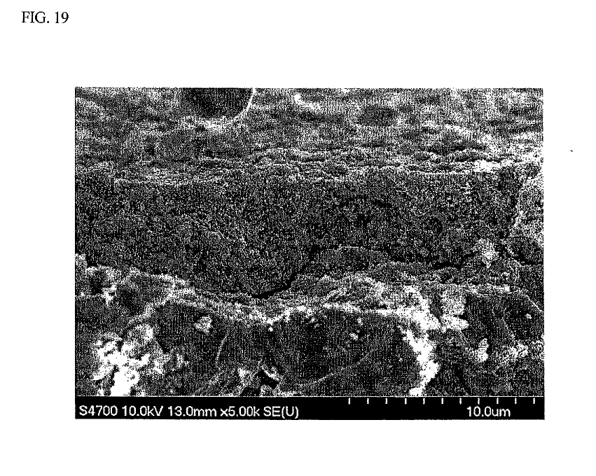

FIG. 18 is an SEM image showing a surface of the coated DOC, while FIG. 19 is an SEM image showing a cross-section of the coated DOC.

As shown in FIGS. 18 and 19, it can be seen that, when only Pt—W/TiO2 having a fine particle diameter is applied to DOC/cDPF, porosity of the catalyst Pt—W/TiO2 layer is low, thus causing a problem in contact between the catalyst and exhaust gas of a vehicle.

Performance of DOC/cDPF was determined by the same procedure described in Example 6.

TABLE 1 shows results of the experiment.

Compared to zeolite-free DOC/cDPF (Example 6), activity was relatively low. However, the activity was remarkably improved, as compared to results of a control (Comparative Example 2).

Although preferred embodiments of the present invention have been described for illustrative purposes, those skilled in the art will appreciate that various alterations and modification are possible, without departing from the scope and spirit of the present invention as disclosed in the appended claims.

### INDUSTRIAL APPLICABILITY

According to the present invention, a bifunctional catalyst for simultaneously expressing activities in relation to NO direct decomposition and NO₂ generation or a composite catalyst for an exhaust gas reducing device for a diesel vehicle which includes a catalyst for simultaneously removing nitrogen oxide and particulate matters have been developed and used to fabricate an exhaust gas post-treatment system. According to the foregoing, an exhaust gas purification system that decreases nitrogen oxide without using an alternative reducing agent and, at the same time, enables PM trapped in a filter to be decreased even under conditions of low exhaust gas emission may be provided.

If a bifunctional catalyst simultaneously expressing high activities in relation to NO direct decomposition and NO₂ generation or a composite catalyst according to the present invention is associated with existing SCR catalyst system, an improved exhaust gas purification system that minimizes an amount of a reducing agent to be supplied and, at the same time, maximizes efficiency thereof may be provided.

Moreover, when the inventive catalyst is associated with a forced regeneration system operated by a heat source, a long regeneration period may be applied, as compared to existing systems. Therefore, a post-treatment apparatus having excellent thermal efficiency may be provided and, at the same time, nitrogen oxide may partially undergo direct decomposition.

1. A method for preparation of a bifunctional catalyst for simultaneously removing nitrogen oxide and particulate matters (PMs) to enable nitrogen monoxide (NO) decomposition and nitrogen dioxide (NO₂) generation through NO oxidation, the method comprising:
(a) loading a co-catalyst based on at least one metal selected from a group consisting of tungsten (W), molybdenum (Mo), cobalt (Co), manganese (Mn), copper (Cu) and iron (Fe) or metal oxides thereof on top of a support containing oxides of at least one element selected from a group consisting of titanium (Ti), zirconium (Zr), aluminum (Al) and cerium (Ce);
(b) loading an active metal based on at least one metal selected from a group consisting of platinum (Pt), palladium (Pd), rhodium (Rh), ruthenium (Ru) and silver (Ag) or metal oxides thereof on top of the co-catalyst; and
(c) drying, calcining and conducting reduction of the loaded materials after loading the co-catalyst and the active metal.

2. The method for preparation of a bifunctional catalyst according to claim 1, wherein the co-catalyst in step (a) is loaded in an amount of 0.1 to 20 wt. % relative to a total weight of the support, and the active metal in step (b) is loaded in an amount of 0.1 to 10 wt. % relative to a total weight of the support.

3. The method for preparation of a bifunctional catalyst according to claim 1, wherein the co-catalyst and the active metal are simultaneously or sequentially loaded in step (c).

4. The method for preparation of a bifunctional catalyst according to claim 1, wherein step (c) further comprises:
after simultaneously or sequentially loading the co-catalyst and the active metal and calcining the loaded materials to form a particulate catalyst, loading the co-catalyst on an outer surface of the active metal in the presence of the particulate catalyst; and,
after loading the co-catalyst on the outer surface of the active metal, sequentially drying, calcining and conducting reduction of the loaded active metal.

5. The method for preparation of a bifunctional catalyst according to claim 4, wherein the co-catalyst is loaded on the outer surface of the active metal in an amount of 0.1 to 10 wt. % relative to a total weight of the support.

6. A method for preparation of a composite catalyst for an exhaust gas reducing device mounted on a diesel vehicle, the method comprising:
(a) loading a co-catalyst based on at least one metal selected from a group consisting of tungsten (W), molybdenum (Mo), cobalt (Co), manganese (Mn), copper (Cu) and iron (Fe) or metal oxides thereof on top of a support containing oxides of at least one element selected from a group consisting of titanium (Ti), zirconium (Zr), aluminum (Al) and cerium (Ce);
(b) loading an active metal based on at least one metal selected from a group consisting of platinum (Pt), palladium (Pd), rhodium (Rh), ruthenium (Ru) and silver (Ag) or metal oxides thereof on top of the co-catalyst;
(c) drying, calcining and conducting reduction after loading the co-catalyst and the active metal, to thereby obtain a catalyst powder; and
(d) mixing the catalyst powder with beta-zeolite, an inorganic binder and a dispersant to produce a composite catalyst.

7. The method for preparation of a composite catalyst according to claim 6, wherein the catalyst powder is added in an amount of 30 to 95 wt. % relative to a total weight of the composite catalyst, the inorganic binder is any one selected from a group consisting of alumina, titania and silicon, and the dispersant is water or alcohol.
